(19) United States
(12) Patent Application Publication
(10) Pub. No.: US 2015/0134438 A1
(43) Pub. Date: May 14, 2015

(54) METHOD AND SYSTEM FOR ESTIMATING REWARDS EARNED FROM CARD TRANSACTIONS

(71) Applicant: MasterCard International Incorporated, Purchase, NY (US)

(72) Inventors: Pedro J. Chavarria, Hampton Bays, NY (US); Kristofer Perez, New York, NY (US)

(73) Assignee: MasterCard International Incorporated, Purchase, NY (US)

(21) Appl. No.: 14/079,002

(22) Filed: Nov. 13, 2013

(51) Int. Cl. G06Q 30/02

(52) U.S. Cl. CPC G06Q 30/0226
USPC 705/14.27

(57) ABSTRACT

An indication is received of a transaction between a cardholder and a merchant, wherein a card is used by the cardholder for the transaction, and the card is an instance of one of a plurality of card products available from respective ones of a plurality of card issuers. From a computer database that has stored therein a set of one or more reward parameters associated with each card product, a selected set of reward parameters associated with said one card product is retrieved. An amount and a merchant identifier are determined for the transaction. At one or more computer processors, an estimate of rewards earned due to the transaction is generated, wherein the estimate is generated prior to a clearance of the card transaction and is based on at least the amount and the retrieved set of reward parameters.

### FIELD

Aspects of the present disclosure relate in general to processing data related to card transactions, and more particularly to fast, accurate estimation rewards earned from card transactions.

### BACKGROUND

Rewards programs have become popular and prevalent in a variety of contexts in the marketplace. Rewards programs, also known by various other names such as incentive programs, loyalty programs, or points programs, are designed to encourage repetitive consumption, buying, or usage behavior. Recently, rewards programs pertaining to payment cards have proliferated. Numerous card issuers offer a variety of card products that enable people to earn and accumulate rewards based on the usage of cards. This type of reward program is especially attractive to many people because of the widespread use of payment cards in society.

Card rewards programs exist in various forms. For example, some cards provide cash back with each transaction (typically as a percentage of the amount of the transaction, e.g., 1% cash back), others provide points that can used to acquire various goods or services (e.g., 1 point for every dollar charged to a credit card), and others provide goods or services directly (e.g., a discrete good or service whenever a card is used for a transaction exceeding a fixed amount). Some card rewards programs provide rewards that are dependent on the type of transaction (e.g., 1 point for each dollar charged at any gas station, 2 points for each dollar charged at any supermarket, 3 points for each dollar charged at a particular merchant, etc.). Regardless of the form in which rewards are characterized (e.g., as cash, points, discrete goods/services, or any other form), cardholders typically can learn the status and extent of their rewards through periodic statements (e.g., monthly statements), online portals (e.g., web portals), or telephone inquiries to an appropriate entities.

But with traditional technologies there is considerable delay associated with updating and reporting the rewards earned for a particular card transaction. For example, a cardholder who uses a rewards card for a transaction and desires to know how many points she earned is typically forced to wait at least several days (and often a week or more). Such a delay is frustrating for cardholders and may inhibit widespread participation in such rewards programs.

### SUMMARY

In some embodiments of the present disclosure, an indication is received of a transaction between a cardholder and a merchant, wherein a card is used by the cardholder for the transaction, and the card is an instance of one of a plurality of card products available from respective ones of a plurality of card issuers. From a computer database that has stored therein a set of one or more reward parameters associated with each card product, a selected set of reward parameters associated with said one card product is retrieved. An amount and a merchant identifier are determined for the transaction. At one or more computer processors, an estimate of rewards earned due to the transaction is generated, wherein the estimate is generated prior to a clearance of the card transaction and is based on at least the amount and the retrieved set of reward parameters.

In some embodiments, transaction data is received regarding a transaction, between a cardholder and a merchant, attempted by the cardholder using a card. From the transaction data, at least an amount of the transaction, a card identifier identifying the card, and a merchant identifier identifying the merchant are determined. At one or more computer processors, the card is matched to one of a plurality of sets of one or more reward parameters stored at a computer database, each set of stored reward parameters associated with a different card product among a plurality of card products. The matching may be based on the card identifier. At the one or more computer processors, an estimate of rewards earned by the cardholder due to the transaction is generated, wherein the estimate is generated on the same day as the use of the card by the cardholder based on the transaction data and the reward parameters matched to the card.

In some embodiments, a system comprises at least one computer processor, a computer database, and a non-transitory computer-readable storage medium having instructions stored tangibly thereon. Multiple sets of one or more reward parameters are stored in the database. The sets of reward parameters are associated with respective card products among a plurality of card products available from one or more card issuers. The instructions stored on the computer-readable storage medium, when executed by the computer processor(s), cause the computer processor(s) to receive an indication of a transaction between a cardholder and a merchant, wherein a card is used by the cardholder for the transaction, and the card is an instance of one card product in the plurality of card products. An amount and a merchant identifier for the transaction are determined. The set of reward parameters associated with said one card product is retrieved from the database. The computer processor(s) generate an estimate of rewards earned due to the transaction, wherein the estimate is generated prior to clearance of the transaction and is based on at least the amount and the set of reward parameters associated with said one card product retrieved from the database.

### BRIEF DESCRIPTION OF THE DRAWINGS

The following will be apparent from elements of the figures, which are provided for illustrative purposes and are not necessarily to scale.

FIG. 1 is a flow diagram of a known process for posting rewards data for a transaction.

FIG. 2 is a process of a flow diagram in accordance with some embodiments of the present disclosure.

FIG. 3 is an interaction diagram of a process in accordance with some embodiments.

FIG. 4 is an architecture diagram of a computer that may be used in some embodiments.

FIG. 5 is a flow diagram of a process in accordance with some embodiments.

FIG. 6 is a flow diagram of a process in accordance with some embodiments.

### DETAILED DESCRIPTION

This description of the exemplary embodiments is intended to be read in connection with the accompanying drawings, which are to be considered part of the entire written description.

Various embodiments of the present disclosure address the foregoing drawbacks of traditional processing for card rewards programs, namely, the delay associated with reporting rewards accrued for transactions and the resulting frustration experienced by cardholders.

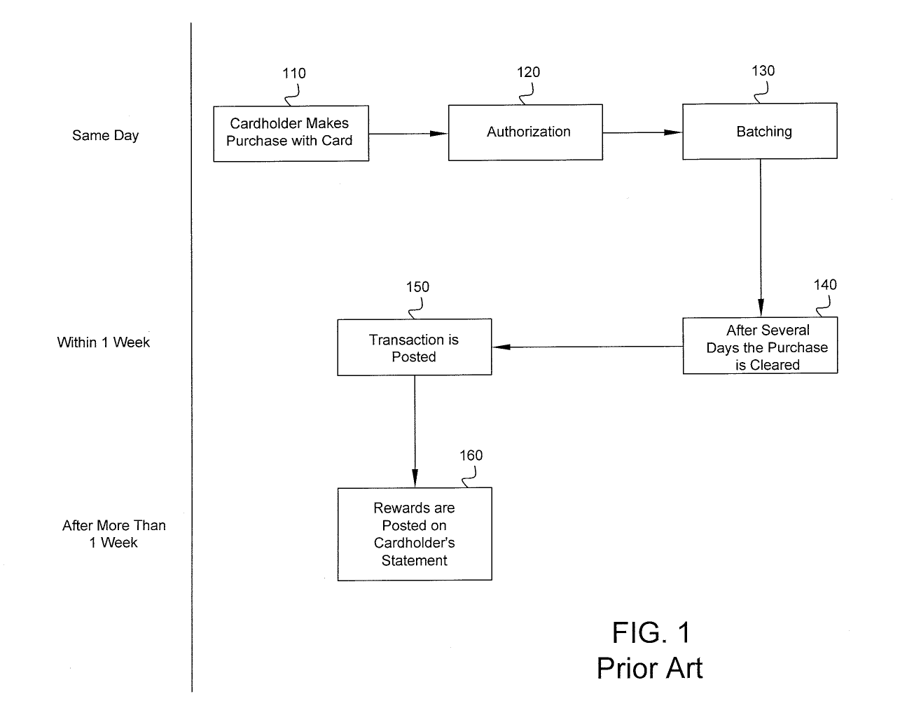

When a credit card is presented as payment to a merchant for a purchase, various processing occurs among a number of entities. FIG. 1 is a flow diagram of a known process for posting rewards data for a credit card transaction, resulting in lengthy delay that is frustrating for cardholders. On the same day that a cardholder makes a purchase with a card (i.e., presents the card to a merchant as payment for any good(s)/service(s)) (block 110), data regarding the card and the transaction are used to authorize the transaction (block 120), and the transaction is batched with other transactions from that day (block 130). Authorization 120 refers to a process in which the merchant electronically sends data regarding a requested purchase to a merchant bank (also known as an acquirer), the merchant bank electronically sends the data regarding the request to the issuer of the card (e.g., via a card processing network), the issuer electronically sends to the merchant bank (e.g., via the card processing network) an indication that the cardholder has sufficient credit for the transaction, and the merchant bank forwards the authorization to the merchant. Batching 130 refers to a process in which all of the authorized transactions for the day are collected in a batch (are batched) and the merchant sends the batch to the merchant bank at the end of day.

After several days, the purchase is cleared (block 140). As one skilled in the art will appreciate, to clear the transaction, the merchant bank sends the batch of transactions corresponding to a single day to a card processing network, which routes respective transactions to the relevant issuer. The issuer sends the funds to the card network, which then routes the funds to the merchant bank. The merchant then receives the funds from the merchant bank, minus certain fees. The clearance process takes several days (typically three to five days). Then, the transaction is posted (block 150), and the accrued rewards associated with transaction are posted on the cardholder's statement (block 160), which is typically provided to the cardholder electronically (e.g., via a web portal or a software application connected to the Internet), by telephone, or by traditional mail. Thus, with existing processing methodology, the rewards accruing to the cardholder as a result of the transaction are only available for viewing by the cardholder a relatively long time (e.g., more than one week) after the purchase.

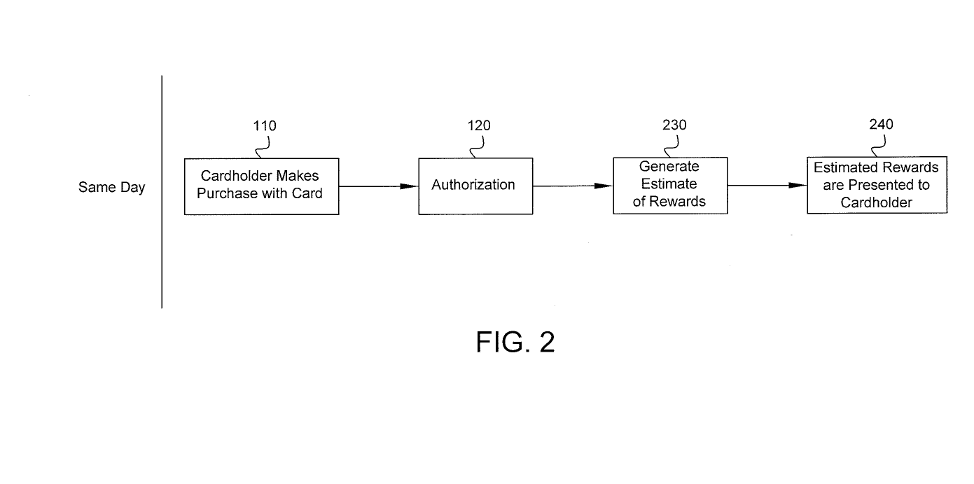

FIG. 2 is a process of a flow diagram in accordance with some embodiments of the present disclosure. A cardholder presents a card (e.g., payment card such as a credit card, debit card, gift card, or prepaid card) as payment to a merchant at block 110. The card may be presented to the merchant, e.g., as a point of sale (POS) terminal that may include a card reader, as payment for a purchase, rental, or any other type of exchange for which payment is appropriate. A purchase is described in some examples herein for convenience, but presentation of a card for a rental is equally applicable, for example. The cardholder may be any person or entity having a card. The card may be a payment card, which may include, but is not limited to, for example, credit cards, debit cards, stored value cards, or other payment devices associated with payment accounts. A payment card or loyalty card may be embodied in various tangible forms, including, for example, as a magnetic stripe card, a radio frequency identification (“RFID”) card or other “contactless” card, smart card, or the like. Further, embodiments may also be used in conjunction with virtual cards (e.g., where no physical card is used for a transaction, such as in a digital wallet), or other payment devices (such as, for example, contactless key fobs, payment-enabled mobile devices or telephones, or the like).

The merchant may be any type of person or entity that accepts a card as a valid form of payment for good(s)/service(s). The card may be presented to the merchant in any manner. For example, the card may be presented (e.g., swiped) at a card reader, card data may be entered (e.g., manually) via a terminal, an image of the card may be processed, an electronic component on the card may be scanned or may transmit a signal representing card data, or any other technique may be used to provide to the merchant the card data (e.g., card number, expiration date, and/or card verification value, and/or other card parameters).

After the purchase is authorized (block 120), an estimate of the rewards accrued due to the transaction is generated (block 230). The estimated rewards are presented to the cardholder (block 240), e.g., posted on the cardholder's electronic statement (for viewing at a web portal or with a software application connected to the Internet, for example). The estimated rewards accrued due to the transaction could also be made available by telephone (e.g., so that the cardholder may call a human operator or an automated agent to obtain the rewards estimate shortly after the transaction is complete), or by any other method of delivering information in real time. Blocks 230 and 240 may occur in real-time, thus making the estimated rewards available to the cardholder without the lengthy delays associated with batching and clearance.

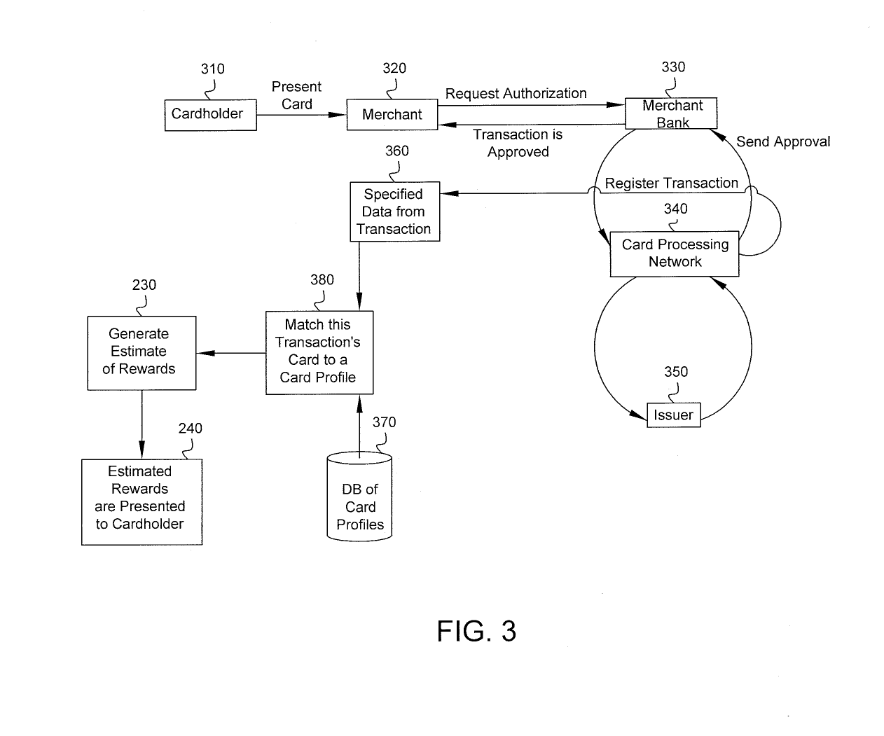

FIG. 3 is an interaction diagram of a process in accordance with some embodiments, with more detail regarding authorization and reward estimation. A cardholder 310 presents a card to a merchant 320 for a transaction. Merchant 320 contacts merchant bank 330 (acquirer 330) for authorization for the transaction. Merchant bank 330 contacts card processing network 340 (also known as card processor 340 or card network 340), which contacts the issuer 350 to determine if the cardholder has sufficient funds or credit. The issuer can be any bank, credit union, financial institution or other company or entity that issues cards or is involved in issuing cards to cardholders. If the cardholder has sufficient funds or credit, the issuer approves the transaction as one skilled in the art will appreciate. At this stage in the processing, the card network 340 sends an approval to merchant bank 330 and also registers the transaction. Specified or predetermined data from the transaction are determined (block 360) for card registration. This predetermined data may include the amount of the transaction, a merchant identifier that identifies the merchant, a card identifier (e.g., card number). Other data such as the date of the transaction may also be determined.

A database of card profiles 370 includes information regarding one or more card products that issuer 350 makes available. For example, issuer 350 (or any other issuer) may issue cards corresponding to various card products. Each card (e.g., physical or virtual card) that is issued to a user is an instance of a particular card product. A user may have a first card that is an instance of a first card product and a second card that is an instance of a second card product from the same or different issuer as the first card. The two card products may provide different parameters by which the user may earn rewards for each purchase made with each card. A set of one or more rewards parameters associated with each card product is stored in database 370. The set of one or more rewards parameters associated with a particular card product is also associated with any card that is an instance of that card product. Based on the specified data 360 (e.g., based on the card identifier that identifies the card used in the present transaction), one of the stored sets of reward parameters (i.e., one of the card profiles) is retrieved from database 370 (block 380). The reward parameters for the matching card profile are used to generate the estimate of the rewards accrued due to the transaction (block 230). The estimate is generated prior to clearance of the card transaction and is based on at least the amount of the transaction and the retrieved set of reward parameters. The estimated rewards are presented to the cardholder (block 240). The estimated rewards may be an estimate of any type of rewards, e.g., points, miles, cash back or a discount to be redeemable for the present transaction or future transaction(s), or any other type of reward or incentive.

In some embodiments, the rewards estimate is further based on the merchant identifier, and at least one of the reward parameters in the retrieved set of reward parameters is dependent on the identity of the merchant. For example, issuer 350 may have a card product that yields 1 point per dollar spent at any merchant, plus a one-time additional 1000 points when the cardholder first uses her card at a given merchant. This rule can be stored in database 370 in the form of suitable reward parameters, and the merchant identifier can be used to determine that the present transaction is a transaction corresponding to that given merchant, and the rewards estimate is generated accordingly.

In some embodiments, a merchant category code (MCC) for the present transaction is also determined when the transaction is registered. The MCC is a classification code that classifies merchants based on the types of goods/services they provide. The MCC may have the format of a four digit code. The merchant identifier may be used to look-up the MCC, e.g., with a table mapping merchant identifiers to MCCs. At least one of the reward parameters in the retrieved set of reward parameters may be dependent on the merchant category code. For example, a particular card may yield an additional 1000 points for any transaction made at any drug store or pharmacy, corresponding to the merchant category code “5912”. This rule can be stored in at least one database 370 in the form of suitable reward parameters, and the estimate can be generated based on the rule.

Because database 370 aggregates data regarding various card products of various issuers, cardholders can seamlessly receive real-time rewards estimates regardless of which card is used. Whereas one issuer does not know the activities of a cardholder regarding a card issued by another issuer, embodiments of the present disclosure register the transaction and determine specified data regarding the transaction based on information that is available to the card network 340 and therefore not confined to the knowledge or awareness of any single issuer.

In some embodiments, the database 370 can be updated with a new set of one or more reward parameters for at least one card product responsive to a change in a reward policy by a corresponding card issuer. For example, an issuer may change the amount of points awarded per dollar spent with a particular card, and that change in the card profile can be recorded at database 370. Database 370 may be updated and/or maintained in various ways. For example, database 370 may be maintained by card network 340, which may poll one or more issuers (e.g., periodically, such as monthly, or aperiodically) for any updates to the rewards policies for any card products available from the issuers. Alternatively, one or more databases 370 may be maintained and/or updated by one or more issuers. For example, each issuer may maintain its own database 370 containing rewards parameters for its card products, and information from the database can be outputted to enable rewards estimates to be computed. As another option, database 370 may be maintained by card network 340 and may be updated based on electronic messages received from cardholders. With this approach, which may be referred to as crowd sourcing, individual cardholders may provide notifications (e.g., at a web portal or via a software application) regarding changes in the rewards programs for their rewards cards. One of ordinary skill in the art will appreciate that any combination of these maintenance/updating techniques, or additional maintenance/updating techniques, can be used to store and update reward parameters.

It is possible that an issuer may have recently changed its rewards policy for a given card product without that change being reflected yet at database 370. In that case, the given card product's stored profiles (set of reward parameter(s)) may be stale and may lead to an estimate that does not reflect the true amount of rewards earned by a transaction. The estimated rewards may be reconciled subsequent to generation or display of the estimate, e.g., reconciliation at the end of the month. Estimates may also be modified based on post-clearance events, such as returns. For example, if a cardholder buys a book with a rewards card and earns 50 points, the estimate of the accrued rewards is generated based on information available during the authorization process. That estimate may be presented (e.g., displayed) to the cardholder in real-time. If the cardholder later returns the book to the merchant for a refund, the estimate may be modified as part of the reconciliation process, so that the accrued rewards for the book purchase are canceled.

In some embodiments, an initial rewards balance (e.g., points balance) is determined during registration, which corresponds to the balance prior to the accrual of any rewards due to the present transaction. The initial points balance may be added (e.g., at one or more computer processors) to the estimated number of accrued points for the present transaction, to generate a final points balance. The final points balance may be presented to the cardholder in real-time.

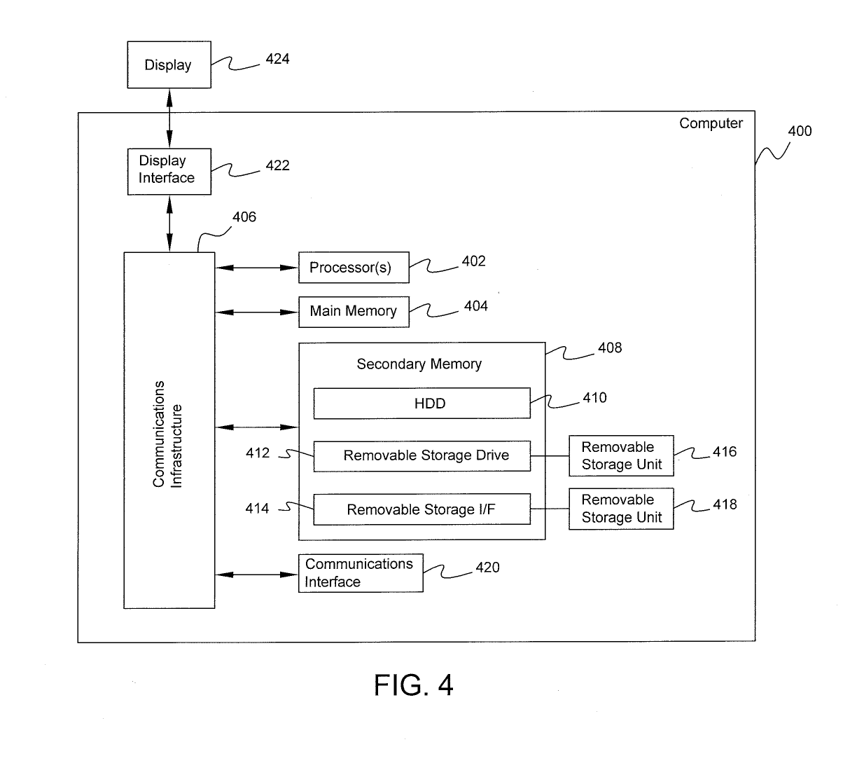

FIG. 4 is an architecture diagram of a computer 400 that may be used in some embodiments. Computer system 400 may include one or more processors 402. Each processor 402 is connected to a communication infrastructure 406 (e.g., a communications bus, cross-over bar, or network). Computer system 400 may include a display interface 422 that forwards graphics, text, and other data from the communication infrastructure 406 (or from a frame buffer, not shown) for display on the display unit 424.

Computer system 400 may also include a main memory 404, such as a random access memory (RAM), and a secondary memory 408. The secondary memory 408 may include, for example, a hard disk drive (HDD) 410 and/or removable storage drive 412, which may represent a floppy disk drive, a magnetic tape drive, an optical disk drive, a memory stick, or the like as is known in the art. The removable storage drive 412 reads from and/or writes to a removable storage unit 416. Removable storage unit 416 may be a floppy disk, magnetic tape, optical disk, or the like. As will be understood, the removable storage unit 416 may include a computer readable storage medium having tangibly stored therein (embodied thereon) data and/or computer software instructions, e.g., for causing the processor(s) to perform various operations.

In alternative embodiments, secondary memory 408 may include other similar devices for allowing computer programs or other instructions to be loaded into computer system 400. Secondary memory 408 may include a removable storage unit 418 and a corresponding removable storage interface 414, which may be similar to removable storage drive 412, with its own removable storage unit 416. Examples of such removable storage units include, but are not limited to, USB or flash drives, which allow software and data to be transferred from the removable storage unit 416, 418 to computer system 400.

Computer system 400 may also include a communications interface 420. Communications interface 420 allows software and data to be transferred between computer system 400 and external devices. Examples of communications interface 420 may include a modem, Ethernet card, wireless network card, a Personal Computer Memory Card International Association (PCMCIA) slot and card, or the like. Software and data transferred via communications interface 420 may be in the form of signals, which may be electronic, electromagnetic, optical, or the like that are capable of being received by communications interface 420. These signals may be provided to communications interface 420 via a communications path (e.g., channel), which may be implemented using wire, cable, fiber optics, a telephone line, a cellular link, a radio frequency (RF) link and other communication channels.

In this document, the terms “computer program medium” and “non-transitory computer-readable storage medium” refer to media such as, but not limited to, media at removable storage drive 412, or a hard disk installed in hard disk drive 410, or removable storage unit 416. These computer program products provide software to computer system 400. Computer programs (also referred to as computer control logic) may be stored in main memory 404 and/or secondary memory 408. Computer programs may also be received via communications interface 420. Such computer programs, when executed by a processor, enable the computer system 400 to perform the features of the methods discussed herein. For example, main memory 404, secondary memory 408, or removable storage units 416 or 418 may be encoded with computer program code (instructions) for performing operations corresponding to various processes disclosed herein.

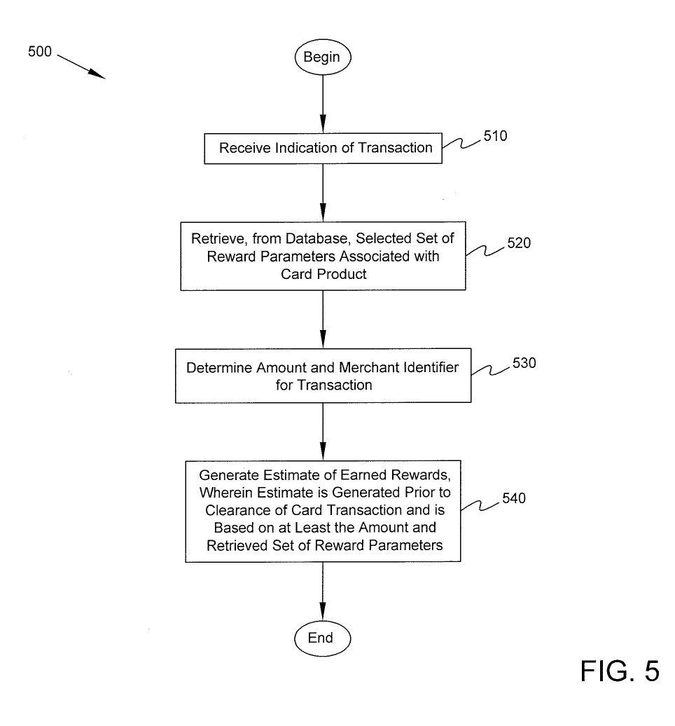

FIG. 5 is a flow diagram of a process in accordance with some embodiments. After process 500 begins, an indication is received (block 510) of a transaction between a cardholder and a merchant, wherein a card is used by the cardholder for the transaction, and the card is an instance of one of a plurality of card products available from respective ones of a plurality of card issuers. From a computer database that has stored therein a set of one or more reward parameters associated with each card product, a selected set of reward parameters associated with said one card product is retrieved (block 520). An amount and a merchant identifier are determined for the transaction (block 530). At one or more computer processors, an estimate of rewards earned due to the transaction is generated (block 540), wherein the estimate is generated prior to a clearance of the card transaction and is based on at least the amount and the retrieved set of reward parameters. Any one or more of blocks 510, 520, 530, and 540 may correspond to processing that occurs at the one or more computer processors.

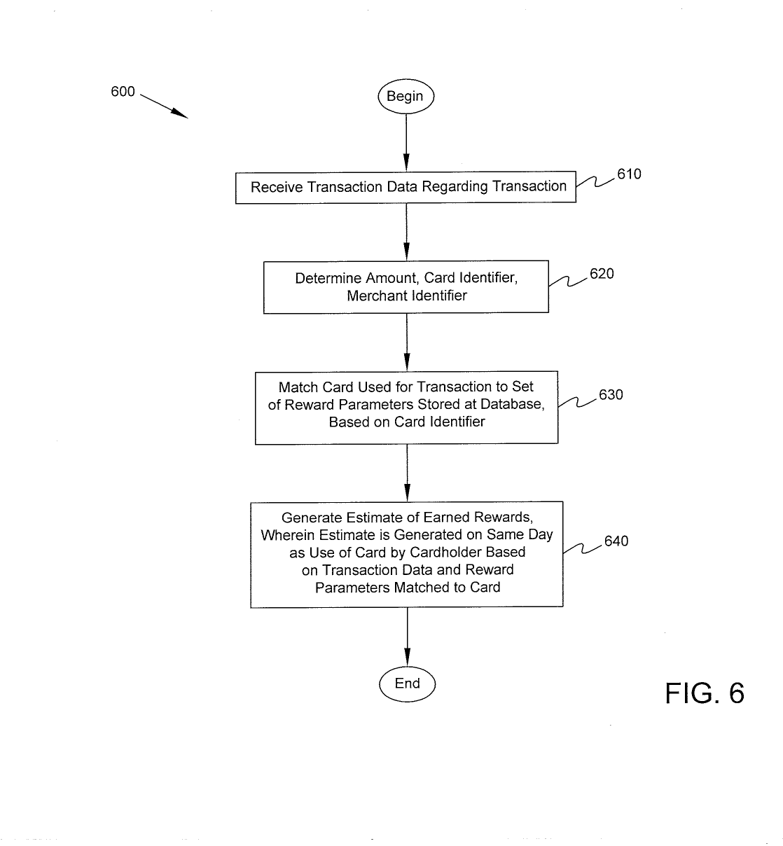

FIG. 6 is a flow diagram of a process in accordance with some embodiments. After process 600 begins, transaction data is received (block 610) regarding a transaction, between a cardholder and a merchant, attempted by the cardholder using a card. From the transaction data, at least an amount of the transaction, a card identifier identifying the card, and a merchant identifier identifying the merchant are determined (block 620). At one or more computer processors, the card is matched (block 630) to one of a plurality of sets of one or more reward parameters stored at a computer database, each set of stored reward parameters associated with a different card product among a plurality of card products. The matching may be based on the card identifier. At the one or more computer processors, an estimate of rewards earned by the cardholder due to the transaction is generated (block 640), wherein the estimate is generated on the same day as the use of the card by the cardholder based on the transaction data and the reward parameters matched to the card. Any one or more of blocks 610, 620, 630, and 640 may correspond to processing that occurs at the one or more computer processors

It is understood by those familiar with the art that the system described herein may be implemented in hardware, firmware, or software encoded on a non-transitory computer-readable storage medium.

The systems and processes are not limited to the specific embodiments described herein. In addition, components of each system and each process can be practiced independent and separate from other each process can be practiced independent and separate from other components and processes described herein.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A method comprising:
receiving an indication of a transaction between a cardholder and a merchant, wherein a card is used by the cardholder for the transaction, and the card is an instance of one card product among a plurality of card products available from respective ones of a plurality of card issuers;
retrieving, from a computer database having stored therein a set of one or more reward parameters associated with each card product, a selected set of reward parameters associated with said one card product;
determining an amount and a merchant identifier for the transaction;
at one or more computer processors, generating an estimate of rewards earned due to the transaction, wherein the estimate is generated prior to a clearance of the card transaction and is based on at least the amount and the retrieved set of reward parameters.

2. The method of claim 1, further comprising displaying the estimate to the cardholder.

3. The method of claim 1, wherein the estimate is further based on the merchant identifier and at least one of the reward parameters in the retrieved set of reward parameters is dependent on the identity of the merchant.

4. The method of claim 3, further comprising determining a merchant category code corresponding to the merchant identifier, wherein at least one of the reward parameters in the retrieved set of reward parameters is dependent on the merchant category code.

5. The method of claim 1, further comprising updating the database with a new set of one or more reward parameters for at least one card product responsive to a change in a reward policy by a corresponding card issuer.

6. The method of claim 1, further comprising:
after the clearance of the card transaction, modifying the estimate based on at least one post-clearance event.

7. The method of claim 6, wherein the at least one post-clearance event includes a return, by the cardholder, of a product associated with the transaction.

8. The method of claim 1, wherein the estimate of rewards earned includes an estimated number of accrued points, the method further comprising:
determining an initial points balance of the cardholder, corresponding to a balance prior to the transaction; and
at the one or more computer processors, adding the initial point balance and the estimated number of accrued points, to generate a final points balance.

9. The method of claim 1, further comprising:
receiving, from the card issuer corresponding to the card used by the cardholder for the transaction, an approval for the transaction, prior to generating the estimate.

10. A method comprising:
receiving transaction data regarding a transaction, between a cardholder and a merchant, attempted by the cardholder using a card;
determining, from the transaction data, at least an amount of the transaction, a card identifier identifying the card, and a merchant identifier identifying the merchant;
at one or more computer processors, matching the card to one of a plurality of sets of one or more reward parameters stored at a computer database, each set of stored reward parameters associated with a different card product among a plurality of card products, wherein the matching is based on the card identifier; and
at the one or more computer processors, generating an estimate of rewards earned by the cardholder due to the transaction, wherein the estimate is generated on the same day as the use of the card by the cardholder based on the transaction data and the reward parameters matched to the card.

11. The method of claim 10, further comprising displaying the estimate to the cardholder.

12. The method of claim 10, wherein the estimate is generated based on the merchant identifier, and at least one of the reward parameters in the retrieved set of reward parameters is dependent on the identity of the merchant.

13. The method of claim 12, further comprising determining a merchant category code corresponding to the merchant identifier, wherein at least one of the reward parameters in the matched set of reward parameters is dependent on the merchant category code.

14. The method of claim 10, further comprising:
receiving, from the card issuer corresponding to the card used by the cardholder for the transaction, an approval for the transaction, prior to generating the estimate.

15. The method of claim 10, further comprising:
after clearance of the card transaction, modifying the estimate based on at least one post-clearance event.

16. The method of claim 10, wherein the estimate of rewards earned includes an estimated number of accrued points, the method further comprising:
determining an initial points balance of the cardholder, corresponding to a balance prior to the transaction;
at the one or more computer processors, adding the initial point balance and the estimated number of accrued points, to generate a final points balance; and
displaying the final points balance to the cardholder.

17. A system comprising:
at least one computer processor;
a computer database having stored therein multiple sets of one or more reward parameters, the sets of reward parameters associated with respective card products among a plurality of card products available from one or more card issuers; and
a non-transitory computer-readable storage medium having instructions stored tangibly thereon, the instructions when executed by the at least one computer processor causing the at least one computer processor to:
receive an indication of a transaction between a cardholder and a merchant, wherein a card is used by the cardholder for the transaction, and the card is an instance of one card product in the plurality of card products;
determine an amount and a merchant identifier for the transaction;
retrieve from the database the set of reward parameters associated with said one card product; and
generate an estimate of rewards earned due to the transaction, wherein the estimate is generated prior to clearance of the transaction and is based on at least the amount and the set of reward parameters associated with said one card product retrieved from the database.

18. The system of claim 17, wherein the estimate is further based on the merchant identifier, and at least one of the reward parameters in the retrieved set of reward parameters is dependent on the identity of the merchant.

19. The system of claim 17, the instructions when executed by the at least one computer processor further causing the at least one computer processor to:
after clearance of the card transaction, modify the generated estimate based on at least one post-clearance event.

20. The system of claim 17, the instructions when executed by the at least one computer processor further causing the at least one computer processor to:
determine an initial points balance of the cardholder, corresponding to a balance prior to the transaction;
add the initial point balance and the estimated number of accrued points, to generate a final points balance; and
cause the final points balance to be displayed to the cardholder.
